(19) United States
(12) Patent Application Publication
(10) Pub. No.: US 2025/0383322 A1
(43) Pub. Date: Dec. 18, 2025

(54) IN-SITU ULTRASONIC DETECTION METHOD AND DEVICE FOR INTERFACE STIFFNESS OF AERO-ENGINE ROTORS BASED ON MICROWAVE TRANSMISSION-LINE THEORY

(71) Applicant: DALIAN UNIVERSITY OF TECHNOLOGY, Dalian (CN)

(72) Inventors: Bo YUAN, Dalian (CN); Zesheng HAN, Dalian (CN); Yingquan WANG, Dalian (CN); Jiahe ZHAO, Dalian (CN); Zeming XIA, Dalian (CN); Qingchao SUN, Dalian (CN)

(21) Appl. No.: 19/240,641

(22) Filed: Jun. 17, 2025

Related U.S. Application Data
(63) Continuation of application No. PCT/CN2024/107162, filed on Jul. 24, 2024.

(51) Int. Cl. G01N 29/09; G01N 29/265

(52) U.S. Cl. CPC G01N 29/09; G01N 29/265; G01N 2291/2693

(57) ABSTRACT

The present invention belongs to the technical field of interface stiffness detection, and discloses an in-situ ultrasonic detection method and device for interface stiffness of aero-engine rotors based on a microwave transmission-line theory. The in-situ ultrasonic detection device for interface stiffness of aero-engine rotors is based on a device matrix and forms the distribution form of an upper and a lower structures through a middle connection structure. Two probes achieve extension and contraction movement by using actuator turntables as the reference respectively. The detection device is positioned and fixed through a clamping mechanism, provides the clamping displacement of the probes through an electromagnet and an adsorption cylinder, and provides the clamping forces of the probes through compression springs. The in-situ ultrasonic detection device for interface stiffness of aero-engine rotors in the present invention can reduce the random influence of sensing boundaries based on the microwave transmission-line theory.

### TECHNICAL FIELD

The present invention belongs to the technical field of interface stiffness detection, and relates to a • n in-situ ultrasonic detection method and device for interface stiffness of aero-engine rotors based on a microwave transmission-line theory.

### BACKGROUND

Components of an aero-engine are connected by bolts. Due to the limitations of processing, assembly and other factors, an engine rotor system has many connection structures. Changes in the local contact states of the structures cause additional unbalance in the rotor system, leading to vibration problems of the entire engine. Therefore, it is of great significance to detect the interface stiffness of an inner cavity part of the aero-engine.

Compared with other measurement means, the ultrasonic measurement technology has the advantages of being free from limitations of material properties, strong in-situ measurement capabilities and high interface measurement sensitivity, and satisfies the basic conditions for in-situ measurement of aero-engine rotors. Wherein particularly important are the robustness of the interface stiffness measurement method and the operability of the narrow space of the aero-engine rotors.

At present, the existing interface stiffness detection has the following problems:
1) Incapability of in-situ detection. A portable ring stiffness detection device and operation method of Li Rui need to place a pipeline to be detected on a detection platform for detection. For the aero-engine rotors, due to the requirements of the detection technology, the detection needs to be carried out at specific stations, which increases the difficulty of the interface stiffness detection of the aero-engine rotors.
2) Poor accessibility. A non-destructive testing device for composite materials and related components thereof based on ultrasonic detection of Jiang Chunyu adopts an open detection device. For the aero-engine rotors, the internal spatial structure at the position of a compressor drum disk is narrow, and the operating space is limited. The existing open detection apparatus is difficult to enter, and the existing rotor is difficult to carry out the related interface stiffness detection work.
3) Poor robustness. An interface stiffness detection device based on solid coupling of Mu Xiaokai does not consider the uncertainty of sensing boundary parameters. For the aero-engine rotors, the sensing boundary parameters have uncertainty in the process of detection, which is extremely likely to cause the reduction of measurement performance and limit the application of interface stiffness measurement.

### SUMMARY

The purpose of the present invention is to solve the problem of detection difficulty of the interface stiffness of the aero-engine, to provide an in-situ ultrasonic detection method and device for interface stiffness of aero-engine rotors based on a microwave transmission-line theory. The present invention can reduce the random influence of sensing boundaries based on the microwave transmission-line theory, can carry out interface stiffness detection in a narrow space of the aero-engine, can use springs to provide pressure to achieve better repeatability, and can use a connecting barrel to realize the synchronous rotation of an upper and a lower structures to improve the coaxiality of an upper and a lower probes.

The technical solution of the present invention is as follows:
The in-situ ultrasonic detection method for interface stiffness of aero-engine rotors based on the microwave transmission-line theory comprises: clamping a fixing jaw 2 onto an inner circular surface of an aero-engine by using the in-situ ultrasonic detection device for interface stiffness of aero-engine rotors; extending an upper ultrasonic probe 28 and a lower ultrasonic probe 36 and positioning same above and below a point to be detected respectively; pressing the upper ultrasonic probe 28 and the lower ultrasonic probe 36 at a position to be detected through a mutual adsorption effect between an electromagnet 12 and an adsorption cylinder 16; emitting ultrasonic signals through the upper ultrasonic probe 28 and the lower ultrasonic probe 36 to obtain a transmission coefficient B₁, an upper surface reflection coefficient C₁₂ and a lower surface reflection coefficient C₄₃; and obtaining the interface stiffness of the point to be detected through calculation;
an expression of the interface stiffness TRDI of the point to be detected is:

$$TRDI = {( \frac{- {B}_{1}^{2} + {( {B}_{1}^{4} + 4 {C}_{12} {C}_{43} {B}_{1}^{2} )}^{0.5}}{2 {C}_{12} {C}_{43}} )}^{0.5}$$

In microwave transmission-line measurement, S₁₁ parameter and S₂₂ parameter are often used for representing reflection characteristics, and S₂₁ parameter is used for representing a transmission characteristic; thus, Cᵢⱼ and B₁ can be obtained; and meanwhile, the TRDI measurement index eliminates the influence of the sensing boundary and only retains the transmission coefficient of a contact interface. Therefore, the utilization of the similarity between an ultrasonic propagation theory and the microwave transmission-line theory is beneficial to reduce a boundary effect and improve the robustness of interface stiffness measurement.

The in-situ ultrasonic detection device for interface stiffness of aero-engine rotors based on the microwave transmission-line theory comprises a device matrix 1, a fixing jaw 2, positioning telescopic rods 3, a fixing compression spring 4, an upper turntable end cover 5, an upper linear guide rail base 6, a lower turntable end cover 7, a lower linear guide rail base 8, an upper rolling bearing 9, a lower rolling bearing 10, a hollow connecting barrel 11, an electromagnet 12, an upper linear guide rail 13, an upper linear slider 14, an upper actuator connecting plate 15, an adsorption cylinder 16, an adsorption cylinder seat 17, a lower linear guide rail 18, a lower linear slider 19, a lower actuator connecting plate 20, an upper actuator adapter plate 21, an upper actuator 22, an upper actuator turntable 23, an upper actuator rotating plate 24, an upper probe connecting rod fixing block 25, an upper probe connecting rod 26, an upper probe housing 27, an upper ultrasonic probe 28, an upper probe compression spring 29, a lower actuator 30, a lower actuator turntable 31, a lower actuator rotating plate 32, a lower probe connecting rod fixing block 33, a lower probe connecting rod 34, a lower probe housing 35, a lower ultrasonic probe 36 and a lower probe compression spring 37.

The device matrix 1 and the hollow connecting barrel 11 are concentric and have hollow cylindrical structures; three positioning telescopic rods 3 are evenly distributed inside the device matrix 1 and the hollow connecting barrel 11; the positioning telescopic rod 3 located outside the hollow connecting barrel 11 is sleeved with the fixing compression spring 4; under the action of the fixing compression spring 4, the positioning telescopic rod 3 is used for positioning and fixing the inner circular surface of the aero-engine; an upper and a lower ends of the device matrix 1 are connected with the upper turntable end cover 5 and the lower turntable end cover 7 through the upper rolling bearing 9 and the lower rolling bearing 10 respectively; the upper turntable end cover 5 and the lower turntable end cover 7 are connected through the hollow connecting barrel 11 to achieve synchronous rotation and clamp the device matrix 1; the upper turntable end cover 5 is connected with the upper linear guide rail base 6, the upper linear guide rail base 6 is connected with the upper linear guide rail 13, the lower turntable end cover 7 is connected with the lower linear guide rail base 8, and the lower linear guide rail base 8 is connected with the lower linear guide rail 18; the electromagnet 12 is connected with the upper actuator connecting plate 15, the adsorption cylinder 16 is connected with the adsorption cylinder seat 17, and the adsorption cylinder seat 17 is connected with the lower actuator connecting plate 20; the mutual adsorption of the electromagnet 12 and the adsorption cylinder 16 provides clamping displacement for the ultrasonic probes; the upper actuator 22 is connected with the upper actuator connecting plate 15 through the upper actuator adapter plate 21, the upper actuator adapter plate 24 is connected with the upper actuator 22 through the upper actuator turntable 23, the upper probe connecting rod 26 is connected with the upper probe adapter plate 54 through the upper probe connecting rod fixing block 25, and the upper ultrasonic probe 28 is connected with the upper probe connecting rod 26 through the upper probe housing 27 and the upper probe compression spring 29; the lower actuator 30 is connected with the lower actuator connecting plate 20, the lower actuator adapter plate 32 is connected with the lower actuator 30 through the lower actuator turntable 31, the lower probe connecting rod 34 is connected with the lower probe adapter plate 63 through the lower probe connecting rod fixing block 33, and the lower ultrasonic probe 36 is connected with the lower probe connecting rod 34 through the lower probe compression spring 37 and the lower probe housing 35; the upper linear slider 14 is fixedly connected with the upper actuator connecting plate 15; the movement of the upper linear slider 14 on the upper linear guide rail 13 drives the linear movement of the upper actuator 22 and the upper ultrasonic probe 28; the lower linear slider 19 is fixedly connected with the lower actuator connecting plate 20; the movement of the lower linear slider 19 on the lower linear guide rail 18 drives the linear movement of the lower actuator 30 and the lower ultrasonic probe 36; the upper actuator 22 is connected with the upper actuator turntable 23 through a spline; the rotation of an output shaft of the upper actuator 22 drives the rotation of the upper actuator rotating plate 24 and the upper ultrasonic probe 28; the lower actuator 30 is connected with the lower actuator turntable 31 through a spline; the rotation of an output shaft of the lower actuator 30 drives the rotation of the lower actuator rotating plate 32 and the lower ultrasonic probe 36; and the upper ultrasonic probe 28 and the lower ultrasonic probe 36 are pressed against the upper probe housing 27 and the lower probe housing 35 respectively under the action of the upper probe compression spring 29 and the lower probe compression spring 37.

The mutual adsorption of the electromagnet 12 and the adsorption cylinder 16 provides clamping displacement for the upper ultrasonic probe 28 and the lower ultrasonic probe 36; Under the clamping displacement action generated by the electromagnet 12 and the adsorption cylinder 16, the upper ultrasonic probe 28 and the lower ultrasonic probe 36 generate a clamping force under the action of the upper probe compression spring 29 and the lower probe compression spring 37.

In a non-detection stage, the electromagnet 12 is not energized and has no magnetism; the upper actuator connecting plate 15 and the lower actuator connecting plate 20 are separated from each other; the upper ultrasonic probe 28 and the lower ultrasonic probe 36 are in a retracted state; at this moment, the upper ultrasonic probe 28 and the lower ultrasonic probe 36 have no clamping force; in a detection stage, the upper ultrasonic probe 28 and the lower ultrasonic probe 36 are extended to the position to be detected; the electromagnet 12 is energized to generate magnetism and is adsorbed with the adsorption cylinder 16 mutually; the upper actuator connecting plate 15 and the lower actuator connecting plate 20 are close to each other, and the upper ultrasonic probe 28 and the lower ultrasonic probe 36 are also close to each other; and under the action of the upper probe compression spring 29 and the lower probe compression spring 37, a clamping force is generated to carry out the detection work of the interface stiffness.

The upper actuator rotating plate 24 and the lower actuator rotating plate 32 are in a retracted state at an initial stage; and after the fixing jaw 2 is positioned and fixed under the action of the positioning telescopic rods 3 and the fixing compression spring 4, the upper actuator rotating plate 24 and the lower actuator rotating plate 32 are extended to move the ultrasonic probes to a region to be detected.

The positioning telescopic rods 3 have lug boss structures, can be clamped on the inner plane of the device matrix 1 in a retracted state to avoid being ejected under the action of the fixing compression spring 4, and are matched with a groove of the device matrix 1 in an extended state so that the fixing jaw 2 is ejected in a specific attitude and fixed on the inner circular surface of the engine.

The beneficial effects of the present invention: the present invention has the characteristic that the present invention can carry out interface stiffness detection in a narrow space of the aero-engine, can use spring rods to provide pressure to achieve better repeatability, and can achieve better stability through the synchronous rotation of the upper and the lower structures.

### DESCRIPTION OF DRAWINGS

FIG. 1 is a schematic diagram of the similarity between ultrasonic transmission and microwave transmission: (a) impedance mismatch in microwave transmission; and (b) interface impedance discontinuity in ultrasonic propagation;

FIG. 2 is a diagram of ultrasonic transmission and reflection results under a multilayer contact interface;

FIG. 3 shows the comparison results of the robustness between a proposed method and a traditional method: (a) statistical histogram of boundary parameters; and (b) box plot of interface stiffness obtained by different methods;

FIG. 4 is an overall structural schematic diagram of a detection device;

FIG. 5 is a side view of a detection device, showing a state when the overall detection device is retracted;

FIG. 6 is a structural schematic diagram showing internal connection of a detection device.

In the figures: 1 device matrix; 2 fixing jaw; 3 positioning telescopic rod; 4 fixing compression spring; 5 upper turntable end cover; 6 upper linear guide rail base; 7 lower turntable end cover; 8 lower linear guide rail base; 9 upper rolling bearing; 10 lower rolling bearing; 11 hollow connecting barrel; 12 electromagnet; 13 upper linear guide rail; 14 upper linear slider; 15 upper actuator connecting plate; 16 adsorption cylinder; 17 adsorption cylinder seat; 18 lower linear guide rail; 19 lower linear slider; 20 lower actuator connecting plate; 21 upper actuator adapter plate; 22 upper actuator; 23 upper actuator turntable; 24 upper actuator rotating plate; 25 upper probe connecting rod fixing block; 26 upper probe connecting rod; 27 upper probe housing; 28 upper ultrasonic probe; 29 upper probe compression spring; 30 lower actuator; 31 lower actuator turntable; 32 lower actuator rotating plate; 33 lower probe connecting rod fixing block; 34 lower probe connecting rod; 35 lower probe housing; 36 lower ultrasonic probe; 37 lower probe compression spring.

### DETAILED DESCRIPTION

Specific embodiments of the present invention are further described below in combination with the drawings and the technical solution.

### Detection Method for Interface Stiffness:

When ultrasonic waves in solid propagate at high frequency, the ultrasonic propagation theory and the microwave transmission-line theory have strong similarity in control equations, boundary conditions and reflection laws. Maxwell's equations of microwaves are composed of four equations and four variables (electric field intensity, magnetic field intensity, charge density and current density). Similarly, the ultrasonic waves in the solid are also composed of four equations and four variables (strain, stress, displacement and velocity). In addition, as shown in FIG. 1, microwave transmission lines and the ultrasonic waves in the solid also have similar propagation laws at discontinuous interfaces. The reflection coefficient R of the ultrasonic waves depends on the acoustic impedances of two materials:

$$R = \frac{{Z}_{1} - {Z}_{2}}{{Z}_{1} + {Z}_{2}} \qquad ( 1 )$$

where Z₁ and Z₂ represent acoustic impedances on both sides of the interface.

The microwaves also have the reflection characteristic when propagating in transmission lines with different characteristic impedances, and the expression form of the reflection coefficient Γ is the same as that of the ultrasonic waves.

$$Γ = \frac{{Z}_{L} - {Z}_{0}}{{Z}_{L} + {Z}_{0}} \qquad ( 2 )$$

where Z_{L} is a terminal load, and Z₀ is a characteristic impedance. The transmission and reflection characteristics can be expressed by S parameter in the microwave transmission-line theory. Therefore, the establishment of an interface stiffness measurement model for reducing the boundary effect can be promoted based on the microwave transmission-line theory.

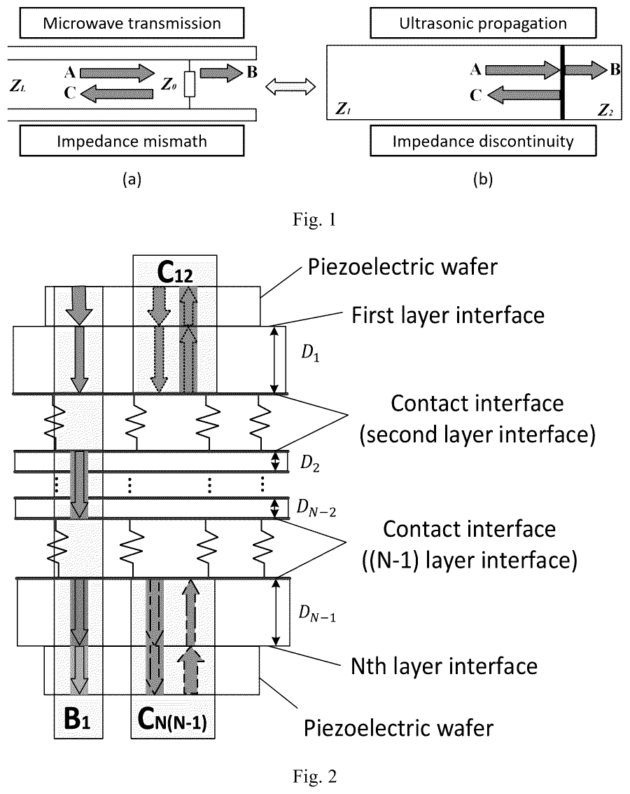

FIG. 2 shows ultrasonic transmission and reflection propagation. As shown in the figure, a top layer and a bottom layer are piezoelectric wafers used for transmitting and receiving ultrasonic waves, and the remaining layers in the middle are metal connected pieces. The ultrasonic waves not only reflect and transmit at a contact interface, but also have reflection characteristics and transmission characteristics at sensing boundaries between the piezoelectric wafers and the metal layers.

As shown in FIG. 2, each time the ultrasonic wave penetrates through an interface, a part of the transmission wave energy is lost. The transmission coefficient B₁ of the first transmission wave can be expressed as:

$${B}_{1} = {t}_{1} {e}^{- γ {D}_{1}} \times … \times {t}_{N - 1} {e}^{- γ {D}_{N - 1}} \times {t}_{N} = {t}_{1} {t}_{2} … {t}_{N - 1} {t}_{N} {e}^{- γ ( {D}_{1} + {D}_{2} + ⋯ + {D}_{N - 1} )} \qquad ( 3 )$$

where tᵢ is a transmission coefficient of the ith layer interface, γ is a propagation constant, and Dᵢ is the thickness of the ith layer structure.

In addition, the reflection coefficient C₁₂ of the first reflection wave at an upper sensing boundary can be expressed as:

$${C}_{12} = {t}_{1} {e}^{- γ {D}_{1}} \times {r}_{2} {e}^{- γ {D}_{1}} \times {t}_{1}^{′} = {t}_{1} {t}_{1}^{′} {r}_{2} {e}^{- 2 γ {D}_{1}} \qquad ( 4 )$$

where rᵢ is a reflection coefficient of the ith layer interface, rᵢₙₜₑᵣ is a reflection coefficient of the contact interface, and tᵢ′ is a back propagation transmission coefficient of the ith layer interface.

Similarly, the reflection coefficient C_{N(N-1)} of the first reflection wave at a lower sensing boundary can be expressed as:

$${C}_{N ( N - 1 )} = {t}_{N} {e}^{- γ {D}_{N - 1}} \times {r}_{N - 1} {e}^{- γ {D}_{N - 1}} \times {t}_{N}^{′} = {t}_{N} {t}_{N}^{′} {r}_{N - 1} {e}^{- 2 γ {D}_{N - 1}} \qquad ( 5 )$$

Although there is a possibility that the transmission coefficients of the ith layer interface are not equal in different propagation directions, the product of the transmission coefficients of the first layer interface and the Nth layer interface in different propagation directions is equal due to the reversibility of the propagation process.

$${t}_{1} \times {t}_{N} = {t}_{1}^{′} \times {t}_{N}^{′} \qquad ( 6 )$$

Because the acoustic propagation loss is relatively small in a metal solid medium with finite thickness, the energy loss mainly comes from a discontinuous interface, and the energy propagation loss in a continuous solid medium is ignored. Meanwhile, assuming that the energy transmission characteristics of the contact interfaces are the same, by combining formulas (3), (4), (5) and (6), the following formula can be obtained:

$$\frac{{C}_{12} {C}_{N ( N - 1 )}}{{B}_{1}^{2}} = \frac{{( {t}_{1} {t}_{N} )}^{2} ( 1 - {t}_{2}^{2} )}{{t}_{1}^{2} {t}_{2}^{2} … {t}_{N - 1}^{2} {t}_{N}^{2}} = \frac{( 1 - {t}_{inter}^{2} )}{{t}_{inter}^{2 ( N - 2 )}} \qquad ( 7 )$$

wherein the geometric mean of the reflection coefficients is generally taken as a comprehensive reflection coefficient.

$$\sqrt{{C}_{12} {C}_{N ( N - 1 )}} = {t}_{1} {t}_{N} {r}_{inter} \qquad ( 8 )$$

For a double-layer connection structure (N=3), i.e., the double-layer connection structure includes one contact interface and two sensing boundaries, formula (7) can be simplified as

$$\frac{{C}_{12} {C}_{32}}{{B}_{1}^{2}} = \frac{( 1 - {t}_{inter}^{2} )}{{t}_{inter}^{2}} \qquad ( 9 )$$

Considering that sensing boundary parameters have the influences of random errors and the uncertainty of probe attitudes, the robustness of a single ultrasonic measurement index is poor. Therefore, an interface stiffness measurement index (TRDI) integrating transmission information and reflection information is proposed. From formula (9), the expression of the interface stiffness measurement index (TRDI) corresponding to the double-layer connection structure can be obtained.

$$TRDI = {t}_{inter} = \frac{{B}_{1}^{2}}{{C}_{12} {C}_{32} + {B}_{1}^{2}} \qquad ( 10 )$$

Similarly, for a three-layer connection structure (N=4), i.e., the three-layer connection structure includes two contact interfaces and two sensing boundaries, formula (7) can be further simplified as

$$\frac{{C}_{12} {C}_{43}}{{B}_{1}^{2}} = \frac{( 1 - {t}_{inter}^{2} )}{{t}_{inter}^{4}} \qquad ( 11 )$$

Similarly, from formula (11), the expression of the interface stiffness measurement index (TRDI) corresponding to the three-layer connection structure can be obtained.

$$TRDI = {t}_{inter} = {( \frac{- {B}_{1}^{2} + {( {B}_{1}^{4} + 4 {C}_{12} {C}_{43} {B}_{1}^{2} )}^{0.5}}{2 {C}_{12} {C}_{43}} )}^{0.5} \qquad ( 12 )$$

In addition, in microwave transmission-line measurement, Su parameter and S₂₂ parameter are often used for representing reflection characteristics, and S₂₁ parameter is used for representing a transmission characteristic; thus, Cᵢⱼ and B₁ can be obtained; and meanwhile, the TRDI measurement index eliminates the influence of the sensing boundaries and only retains the transmission coefficients of the contact interfaces. Therefore, the utilization of the similarity between the ultrasonic propagation theory and the microwave transmission-line theory is beneficial to reduce the boundary effect and improve the robustness of interface stiffness measurement.

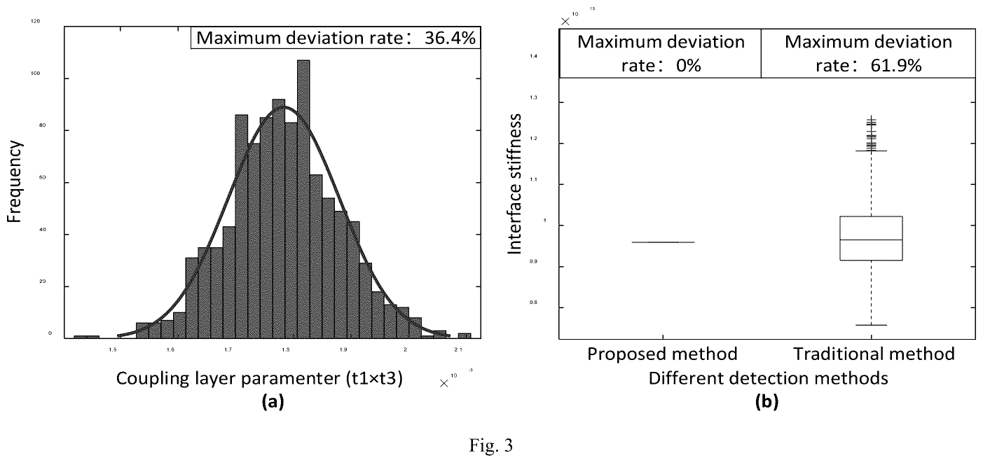

As shown in FIG. 3(a), the sensing boundary parameters present the characteristics of Gaussian distribution, and a maximum deviation rate thereof is 36.4%. FIG. 3(b) shows a box plot of interface stiffness obtained by different methods. It can be seen from the figure that when the deviation rate of coupling layer parameters is 36.4%, the deviation rate of the interface stiffness obtained by the traditional method is 61.9%. This indicates that the fluctuation of the sensing boundary parameters may amplify the measurement error of the traditional method. Therefore, for the traditional method, to reduce the influence brought by the uncertainty of the sensing boundary parameters, collection and statistical analysis should be conducted in RIAP for many times to ensure the accuracy of the measurement results.

It can also be seen from the results that compared with the traditional method, the proposed method is less affected by the uncertainty of the sensing boundary parameters. The reason is that the proposed measurement index uses an intrinsic relationship between the reflection information and the transmission information when calculating the transmission coefficient, thereby reducing the influence of the uncertainty of the sensing boundary parameters on the measurement results. In addition, in some actual measurement processes, due to the special requirements of spatial dimensions and operation technologies for measurement objects, RIAP is difficult to implement. Therefore, compared with the traditional method, the proposed method achieves in-situ measurement of the interface stiffness without the need for calibration reference data, making the method have more practical application prospects.

The in-situ ultrasonic detection device for interface stiffness of aero-engine rotors is designed based on the microwave transmission-line theory.

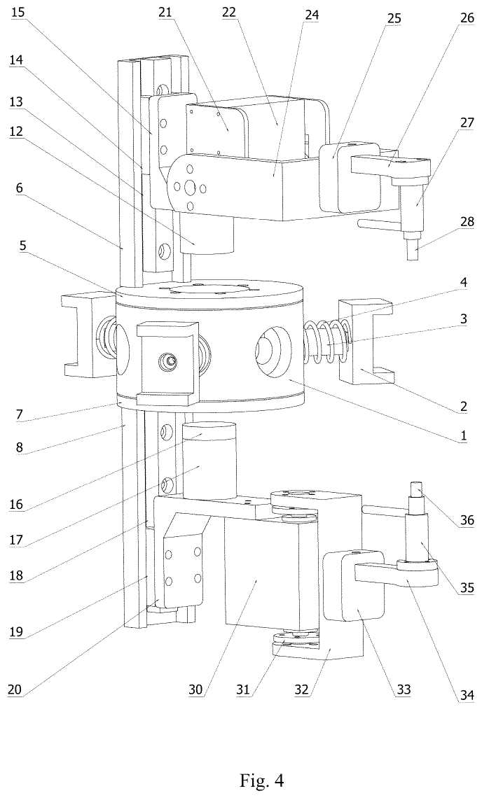

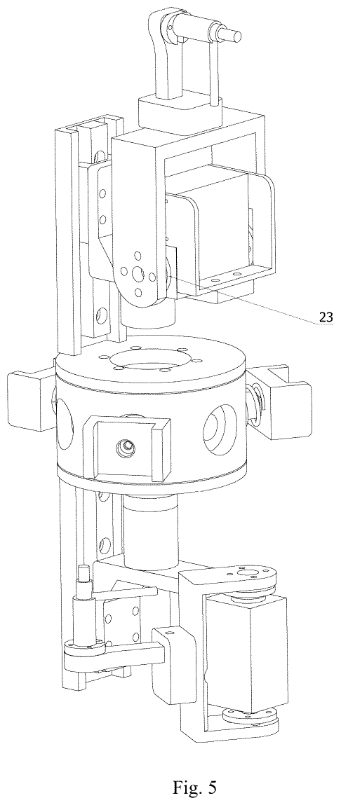

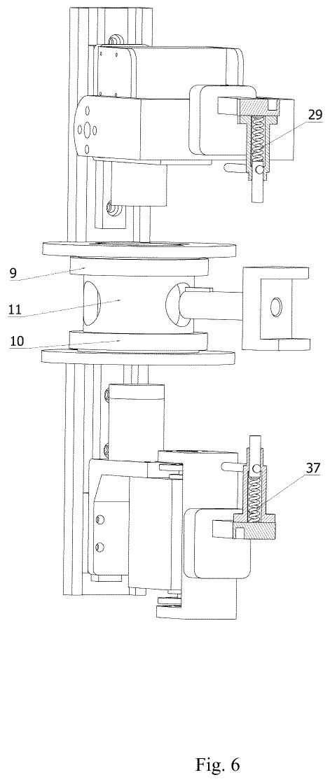

As shown in FIG. 4 to FIG. 6, the present invention is based on the device matrix 1. According to the requirements of ultrasonic transmission detection, the entire device is formed in the form of the upper and the lower structures. The device matrix 1 is connected with the upper turntable end cover 5 and the lower turntable end cover 7 through the upper rolling bearing 9 and the lower rolling bearing 10 respectively. The upper linear guide rail 13, the upper linear guide rail base 6, the upper turntable end cover 5, the hollow connecting barrel 11, the lower turntable end cover 7, the lower linear guide rail base 8 and the lower linear guide rail 18 are connected successively through bolts. The upper actuator 22, the upper actuator adapter plate 21, the upper actuator connecting plate 15 and the upper linear slider are connected successively through bolts. The lower actuator 30, the lower actuator connecting plate 20 and the lower linear slider 19 are connected successively through bolts. The upper actuator 22 is connected with the upper actuator turntable 23 through a spline; and the lower actuator 30 is connected with the lower actuator turntable 31 through a spline. The upper probe housing 27, the upper probe connecting rod 26, the upper probe connecting rod fixing block 25, the upper actuator adapter plate 24 and the upper actuator turntable 23 are connected successively through bolts; and the lower probe housing 35, the lower probe connecting rod 34, the lower probe connecting rod fixing block 33, the lower actuator adapter plate 32 and the lower actuator turntable 31 are connected successively through bolts. The upper ultrasonic probe 28 is fixed to the upper probe housing 27 under the action of the upper probe compression spring 29; and the lower ultrasonic probe 36 is fixed to the lower probe housing 35 under the action of the lower probe compression spring 37.

The device matrix 1 and the hollow connecting barrel 11 are of hollow structures; the mutual adsorption of the electromagnet 12 and the adsorption cylinder 16 provides clamping displacement for the ultrasonic probes; and the upper probe compression spring 29 and the lower probe compression spring 37 provide a clamping force for the ultrasonic probes.

The present invention comprises the following implementation steps:
1) Initial stage: three evenly-distributed positioning telescopic rods 3 contract inside the device matrix 1 and the hollow connecting barrel 11 under the limitations of lug bosses and the fixing compression spring 4; the upper actuator rotating plate 24 is in a vertical retracted state, and the lower actuator rotating plate 64 is in a side edge retracted state. At this moment, the entire device is in a contracted state and enters an inner cavity of a rotor through a narrow inlet of the aero-engine.
2) Detection preparation stage: after reaching a designated position, the three positioning telescopic rods 3 are rotated to make the upper lug boss coincide with the groove of the device matrix 1 and then eject under the action of the fixing compression spring 4; the fixing jaw 2 at the end of the positioning telescopic rod is clamped on the inner circular surface of the aero-engine; and under the action of the same spring force, the concentric positioning effect between the device matrix 1 and the inner circular surface of the aero-engine is ensured. After the positioning telescopic rods 3 and the fixing jaw 2 complete the functions of positioning and clamping, the upper actuator rotating plate 24 and the lower actuator rotating plate 32 are extended to position the upper ultrasonic probe 28 and the lower ultrasonic probe 36 above and below the region to be detected respectively.
3) Detection stage: due to the extension of the positioning telescopic rods 3, the center positions of the device matrix 1 and the hollow connecting barrel 11 are in a hollow state. Under the action of the mutual adsorption of the electromagnet 12 and the adsorption cylinder 16, the upper actuator connecting plate 15 and the lower actuator connecting plate 20 are close to each other and are connected as a whole. The upper ultrasonic probe 28 and the lower ultrasonic probe 36 form a clamping force of 10N with the structure to be detected in the aero-engine to ensure that the contact and stress state of the upper and lower interfaces are the same. After the interface stiffness of a local position is detected, the electromagnet 12 is de-energized to lose the magnetic force. The upper turntable end cover 5 is rotated by a specific angle to reach a next local position to be detected. The above steps are repeated to complete the measurement of an entire cycle.
4) Detection end stage: the electromagnet 12 is de-energized to lose the magnetic force, and is separated from the adsorption cylinder 16 respectively along with the separation of the upper linear slider 14 and the lower linear slider 19. The upper actuator rotating plate 24 and the lower actuator rotating plate are retracted under the action of the upper actuator 22 and the lower actuator 30. The three evenly-distributed positioning telescopic rods 3 are pressed into the device matrix 11 and the hollow connecting barrel 11 and converted to a retracted state. The entire device is moved out of the inner cavity structure of the aero-engine.

1. An in-situ ultrasonic detection device for interface stiffness of aero-engine rotors based on a microwave transmission-line theory, comprising a device matrix (1), a fixing jaw (2), positioning telescopic rods (3), a fixing compression spring (4), an upper turntable end cover (5), an upper linear guide rail base (6), a lower turntable end cover (7), a lower linear guide rail base (8), an upper rolling bearing (9), a lower rolling bearing (10), a hollow connecting barrel (11), an electromagnet (12), an upper linear guide rail (13), an upper linear slider (14), an upper actuator connecting plate (15), an adsorption cylinder (16), an adsorption cylinder seat (17), a lower linear guide rail (18), a lower linear slider (19), a lower actuator connecting plate (20), an upper actuator adapter plate (21), an upper actuator (22), an upper actuator turntable (23), an upper actuator rotating plate (24), an upper probe connecting rod fixing block (25), an upper probe connecting rod (26), an upper probe housing (27), an upper ultrasonic probe (28), an upper probe compression spring (29), a lower actuator (30), a lower actuator turntable (31), a lower actuator rotating plate (32), a lower probe connecting rod fixing block (33), a lower probe connecting rod (34), a lower probe housing (35), a lower ultrasonic probe (36) and a lower probe compression spring (37), wherein
the device matrix (1) and the hollow connecting barrel (11) are concentric and have hollow cylindrical structures; three positioning telescopic rods (3) are evenly distributed inside the device matrix (1) and the hollow connecting barrel (11); the positioning telescopic rod (3) located outside the hollow connecting barrel (11) is sleeved with the fixing compression spring (4); under the action of the fixing compression spring (4), the positioning telescopic rod (3) is used for positioning and fixing an inner circular surface of an aero-engine; an upper and a lower ends of the device matrix (1) are connected with the upper turntable end cover (5) and the lower turntable end cover (7) through the upper rolling bearing (9) and the lower rolling bearing (10) respectively; the upper turntable end cover (5) and the lower turntable end cover (7) are connected through the hollow connecting barrel (11) to achieve synchronous rotation and clamp the device matrix (1); the upper turntable end cover (5) is connected with the upper linear guide rail base (6), the upper linear guide rail base (6) is connected with the upper linear guide rail (13), the lower turntable end cover (7) is connected with the lower linear guide rail base (8), and the lower linear guide rail base (8) is connected with the lower linear guide rail (18); the electromagnet (12) is connected with the upper actuator connecting plate (15), the adsorption cylinder (16) is connected with the adsorption cylinder seat (17), and the adsorption cylinder seat (17) is connected with the lower actuator connecting plate (20); the mutual adsorption of the electromagnet (12) and the adsorption cylinder (16) provides clamping displacement for the ultrasonic probes; the upper actuator (22) is connected with the upper actuator connecting plate (15) through the upper actuator adapter plate (21), the upper actuator adapter plate (24) is connected with the upper actuator (22) through the upper actuator turntable (23), the upper probe connecting rod (26) is connected with the upper probe adapter plate (54) through the upper probe connecting rod fixing block (25), and the upper ultrasonic probe (28) is connected with the upper probe connecting rod (26) through the upper probe housing (27) and the upper probe compression spring (29); the lower actuator (30) is connected with the lower actuator connecting plate (20), the lower actuator adapter plate (32) is connected with the lower actuator (30) through the lower actuator turntable (31), the lower probe connecting rod (34) is connected with the lower probe adapter plate (63) through the lower probe connecting rod fixing block (33), and the lower ultrasonic probe (36) is connected with the lower probe connecting rod (34) through the lower probe compression spring (37) and the lower probe housing (35); the upper linear slider (14) is fixedly connected with the upper actuator connecting plate (15); the movement of the upper linear slider (14) on the upper linear guide rail (13) drives the linear movement of the upper actuator (22) and the upper ultrasonic probe (28); the lower linear slider (19) is fixedly connected with the lower actuator connecting plate (20); the movement of the lower linear slider (19) on the lower linear guide rail (18) drives the linear movement of the lower actuator (30) and the lower ultrasonic probe (36); the upper actuator (22) is connected with the upper actuator turntable (23) through a spline; the rotation of an output shaft of the upper actuator (22) drives the rotation of the upper actuator rotating plate (24) and the upper ultrasonic probe (28); the lower actuator (30) is connected with the lower actuator turntable (31) through a spline; the rotation of an output shaft of the lower actuator (30) drives the rotation of the lower actuator rotating plate (32) and the lower ultrasonic probe (36); and the upper ultrasonic probe (28) and the lower ultrasonic probe (36) are pressed against the upper probe housing (27) and the lower probe housing (35) respectively under the action of the upper probe compression spring (29) and the lower probe compression spring (37);
the mutual adsorption of the electromagnet (12) and the adsorption cylinder (16) provides clamping displacement for the upper ultrasonic probe (28) and the lower ultrasonic probe (36); and under the clamping displacement action generated by the electromagnet (12) and the adsorption cylinder (16), the upper ultrasonic probe (28) and the lower ultrasonic probe (36) generate a clamping force under the action of the upper probe compression spring (29) and the lower probe compression spring (37);
in a non-detection stage, the electromagnet (12) is not energized and has no magnetism; the upper actuator connecting plate (15) and the lower actuator connecting plate (20) are separated from each other; the upper ultrasonic probe (28) and the lower ultrasonic probe (36) are in a retracted state; at this moment, the upper ultrasonic probe (28) and the lower ultrasonic probe (36) have no clamping force; in a detection stage, the upper ultrasonic probe (28) and the lower ultrasonic probe (36) are extended to a position to be detected; the electromagnet (12) is energized to generate magnetism and is adsorbed with the adsorption cylinder (16) mutually; the upper actuator connecting plate (15) and the lower actuator connecting plate (20) are close to each other, and the upper ultrasonic probe (28) and the lower ultrasonic probe (36) are also close to each other; and under the action of the upper probe compression spring (29) and the lower probe compression spring (37), a clamping force is generated to carry out the detection work of the interface stiffness;
the upper actuator rotating plate (24) and the lower actuator rotating plate (32) are in a retracted state at an initial stage; and after the fixing jaw (2) is positioned and fixed under the action of the positioning telescopic rods (3) and the fixing compression spring (4), the upper actuator rotating plate (24) and the lower actuator rotating plate (32) are extended to move the ultrasonic probes to a region to be detected.

2. The in-situ ultrasonic detection device for interface stiffness of aero-engine rotors according to claim 1, wherein the positioning telescopic rods (3) have lug boss structures, can be clamped on the inner plane of the device matrix (1) in a retracted state to avoid being ejected under the action of the fixing compression spring (4), and are matched with a groove of the device matrix (1) in an extended state so that the fixing jaw (2) is ejected in a specific attitude and fixed on the inner circular surface of the engine.

3. An in-situ ultrasonic detection method for interface stiffness of aero-engine rotors based on a microwave transmission-line theory, comprising:
clamping a fixing jaw (2) onto an inner circular surface of an aero-engine by using the in-situ ultrasonic detection device for interface stiffness of aero-engine rotors; extending an upper ultrasonic probe (28) and a lower ultrasonic probe (36) and positioning same above and below a point to be detected respectively; pressing the upper ultrasonic probe (28) and the lower ultrasonic probe (36) at a position to be detected through a mutual adsorption effect between an electromagnet (12) and an adsorption cylinder (16); emitting ultrasonic signals through the upper ultrasonic probe (28) and the lower ultrasonic probe (36) to obtain a transmission coefficient B₁, an upper surface reflection coefficient C₁₂ and a lower surface reflection coefficient C₄₃; and obtaining the interface stiffness of the point to be detected through calculation;
an expression of the interface stiffness TRDI of the point to be detected is:
$$TRDI = {( \frac{- {B}_{1}^{2} + {( {B}_{1}^{4} + 4 {C}_{12} {C}_{43} {B}_{1}^{2} )}^{0.5}}{2 {C}_{12} {C}_{43}} )}^{0.5}$$
